(19) United States
(12) Patent Application Publication
(10) Pub. No.: US 2010/0318926 A1
(43) Pub. Date: Dec. 16, 2010

(54) USER INTERFACE FOR ENTERING ACCOUNT DIMENSION COMBINATIONS

(75) Inventors: Jeffrey R. Anderson, West Fargo, ND (US); Kevin M. Honeyman, Fargo, ND (US); Todd R. Lefor, Fargo, ND (US); Karen D. Mullenberg, Horace, ND (US); Ray C. Babcock, Fargo, ND (US)

Correspondence Address: MICROSOFT CORPORATION, ONE MICROSOFT WAY, REDMOND, WA, 98052, US

(73) Assignee: Microsoft Corporation, Redmond, WA (US)

(21) Appl. No.: 12/484,382

(22) Filed: Jun. 15, 2009

(51) Int. Cl. G06F 3/048; G06Q 10/00

(52) U.S. Cl. 715/763; 705/30

(57) ABSTRACT

User interface features for supporting user-initiated input of a segmented account dimension combination are disclosed. The user interface features may be integrated into a software-based accounting application, for example as part of a user interface mechanism that supports a process for entering the account dimension combination on a general ledger distribution line for a record of a transaction.

### BACKGROUND

Modern business solutions software provides businesses with a vast array of powerful tools. Such solutions are known to provide integrated capabilities for financial management, distribution, manufacturing, project accounting, human resource management, field service management, and business analytics. Within such solutions, one aspect often provides automated business accounting functions.

Corporate accounting software sometimes provides user-definable transaction dimensions for improved tracking and business analytics. A user-definable transaction dimension is similar to a variable that contains additional information relative to a transaction. These user-definable transaction dimensions are used to classify, report, and analyze financial transactions based upon a user's specific business needs. The number of transaction dimensions that can be defined by a user are essentially unlimited and include such dimensions as cost center, profit center and region, as well as predefined system transaction dimensions such as customer, vendor, item, and site. These user-defined transaction dimension codes are attached to ledger transactions which eliminates the need to analyze transactions on the basis of account segments.

The use of financial dimensions to essentially augment or capture relevant business information in a given ledger transaction is highly desirable. Thus, users can now enter a host of additional information relative to a given ledger transaction. However, this feature can also be a limitation if data accuracy is not addressed. For example, a user who erroneously indicates that a ledger transaction is related to a given cost center, when, in fact, the transaction is not so related, runs the risk of generating a chain of errors because the erroneously indicated cost center will show the transaction while the proper cost center will not. Thus, it becomes vitally important that data accuracy is achieved and maintained.

Certain accounting software systems include a relational Chart of Accounts that allows entry of any combination of accounts and dimensions when documenting business activity. An accuracy enforcement mechanism such as account dimension validation rules provide a means to specify which combinations are valid or invalid in order to eliminate user input errors when entering an account and dimension combination. Within many systems, the number of possible combinations of valid values is quite large. From a user's perspective the interfaces provided to facilitate review and selection of valid account dimension components and values are such that the selection process is not particularly logical, user-friendly or efficient. Known entry controls suffer from these and a number of other drawbacks, which will become apparent after reading the specification below.

The discussion above is merely provided for general background information and is not intended for use as an aid in determining the scope of the claimed subject matter.

### SUMMARY

Embodiments disclosed herein pertain to user interface features for supporting user-initiated input of an account dimension combination, such as entry of such a combination on a general ledger distribution line for a record of a transaction within an accounting application. In one embodiment, a data entry interface component includes a series of segmented controls that enable the user to select the account dimension combination without any restriction on the order in which the segmented controls are supplied with values. In another embodiment, the configuration of the series of segmented controls is dynamically modified in response to inputs entered by the user into one or more of the segmented controls. In another embodiment, a fly-out interface component is provided and includes a visual explanation of the nature and status of each control in the series of segmented controls. The fly-out interface is automatically updated as necessary to track and reflect the dynamic modifications to the configuration of the series of segmented controls. In another embodiment, a drop-box interface component provides a list of suggested values relative to a selected one of the series of segmented controls. The drop-box interface component may include auto-complete functionality and is configurable to present suggested values limited to values from a historical record of previously selected values, from a set of valid values and/or from a set that includes invalid values.

This Summary is provided to introduce a selection of concepts in a simplified form and are further described below in the Detailed Description. This Summary is not intended to identify key features or essential features of the claimed subject matter, nor is it intended for use as an aid in determining the scope of the claimed subject matter.

### BRIEF DESCRIPTION OF THE DRAWINGS

FIG. 1 is a schematic block diagram of a simplified financial record system.

FIG. 2 shows a table containing journal entries.

FIG. 3 is a block schematic diagram of a user interface system.

FIG. 4 is a block blow diagram demonstrating steps associated with updating a user interface.

FIGS. 5, 6A, 6B, 7A, 7B, 8A, 8B, 8C, 8D, and 9 are illustrations of user interfaces and components thereof.

FIG. 10 is a block diagram of a computing environment.

### DETAILED DESCRIPTION

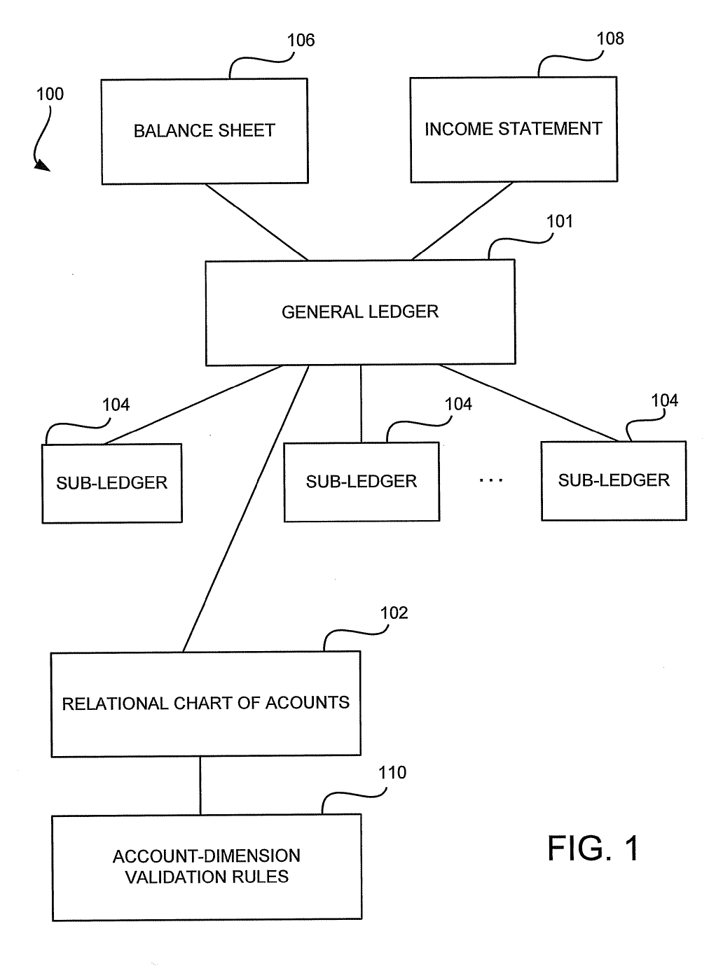

FIG. 1 is a schematic block diagram of a simplified financial record system 100 that represents one context within which embodiments described herein can be implemented. It is common for system 100 to be implemented in the specific context of a software application. System 100 can be a stand-alone financial record keeping (accounting) system, or it can be a financial module of a larger system, such as an enterprise resource planning (ERP) system. It should be noted that, for the purpose of illustrating basic components, system 100 is very simply presented. When actually applied in the context of real-world businesses, the structure of such a system can become quite complex, particularly when applied in the context of a large company having a sophisticated enterprise-oriented organization scheme.

The core of system 100 is general ledger 101. General ledger 101 generally consists of a series of transactions stored on one or more suitable storage devices such as one or more hard disks. All financial transactions flow through general ledger 101 so as to support the creation of a permanent financial history.

System 100 also includes a plurality of sub-ledgers 104 that track specific items such as cash, accounts receivable, accounts payable, payroll, inventory and the like. All entries posted to sub-ledgers 104 will transact through general ledger 101. For example, when a customer pays off a bill with cash, the transaction will be posted to the general ledger and the two appropriate sub-ledgers 104 (e.g., cash and accounts receivable).

System 100 illustratively supports user-definable transaction dimensions for tracking and business analytics. A user-definable transaction dimension is similar to a variable that contains additional information relative to a transaction. These user-definable transaction dimensions are used to classify, report, and analyze financial transactions based upon a user's specific business needs. The number of transaction dimensions that can be defined by a user are essentially unlimited and include such dimensions as cost center, profit center, region, and hours, as well as predefined system transaction dimensions such as customer, vendor, item, and site. These user-defined transaction dimension codes are attached to ledger transactions which eliminates the need to analyze transactions on the basis of account segments.

System 100 includes a relational chart of accounts 102 that includes a listing of accounts associated with general ledger 101. Relational chart of accounts 102 is illustratively relational at least in that it includes zero or more dimensions associated with each account. Some accounts may be listed in multiple instances with different dimension combinations. In one embodiment, a user is provided with an ability to add, remove or otherwise edit dimension settings within system 100 at least by editing relational chart of accounts 102.

In one embodiment, relational chart of accounts 102 is configured to allow the entry of any combination of accounts and dimensions when documenting business activity, so long as each combination complies with a set of user or system defined account dimension validation rules 110. Rules 110 enable a specification of which combinations are valid or invalid. Accordingly, the application of rules 110 is a mechanism for discouraging or eliminating user input errors when entering an account and dimension combination.

In one embodiment, each of a plurality of companies within a single enterprise can operate its own relational chart of accounts 102. For example, an enterprise might have its own overarching chart of accounts that incorporates ties to affiliated companies. Each affiliated company within the enterprise then may have their own chart of accounts without having to keep track of the enterprise. Thus, the enterprise and affiliated companies may utilize a different chart of accounts. In one embodiment, each has control to manipulate dimension configurations (e.g., rules 110) as desired. In one embodiment, rules can be enforced to prevent (and/or limit) manipulation of such dimension configurations. For example, the enterprise might restrict certain companies from manipulating certain dimension configurations.

Balance sheet 106 and income statement (sometime referred to as a “profit and loss” statement) 108 are financial documents that are drawn directly from general ledger 101. More specifically, general ledger 101 will contain the balances that make up line items on reports 106 and 108. Balance sheet 106 is typically configured to provide an overview of financial condition at a given point in time such as at the close of an accounting period. The overview generally includes at least assets (anything the business owns) and liabilities (claims of creditors against assets of the business). In contrast, income statement 108 provides a profit/loss summary during a predetermined period of time, such as a month, quarter or one-year. The summary will generally include revenues and operating expenses for the business during the relevant time period.

It should be noted that system 100 is simplified rather than being exhaustive in scope. For example, most systems will also include revenue, expense, and/or capital withdrawal accounts in the form of temporary accounts that are reset at the end of an accounting period so that they will have zero balances at the start of the next period (commonly one year). Closing entries are the journal entries used to transfer balances of temporary accounts to permanent accounts. After the closing entries have been made, the temporary account balances will be reflected in a more permanent account such as a retained earnings account.

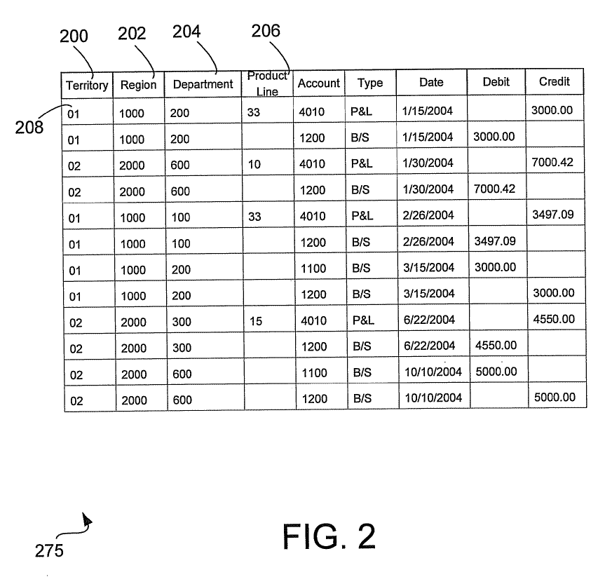

FIG. 2 shows a table 275 containing journal entries, the table being a simplified example of what might be provided as part of a user interface display that is part of a software-implementation of system 100. Those skilled in the art will certainly appreciate that a user is able to select, as well as add or remove data from, at least some if not all of the cells within table 275. Table 275 is intended to demonstrate, on a simplified level, the nature of how transaction dimensions are tracked when documenting business activity.

Within table 275, the user has selected or otherwise defined four distinct dimensions. Territory 200, region 202, department 204, and product line 206 are all user-defined transaction dimensions. A given general ledger transaction line 208 is then augmented with information, to the extent known, relative to the dimensions. For example, transaction line 208 is augmented with territory information indicating that the transaction is related to territory 01, region information indicating region 1000, department information indicating department 200, and product information indicating product line 33. Additionally, each transaction line transacts relative to a selected account and the type of that account is listed, whether it is a profit and loss account (P&L) or a balance sheet (B/S) account.

Table 275 is but one high level example of how dimension date might be utilized within a system like system 100. The scope of the present invention certainly is not limited to such a context. The present invention broadly applies at least to any system component where dimension data is tracked and/or displayed.

In most systems, there is likely to be numerous possible combinations of valid dimensions and valid dimension values that can be utilized to document a transaction. For example, there is likely to be numerous possible combinations of valid values that can be entered into a given transaction line. Embodiments described herein pertain to a user interface control scheme that provides support for efficient and effective user interaction for accurately adding, removing and selecting account dimensions and account dimension values.

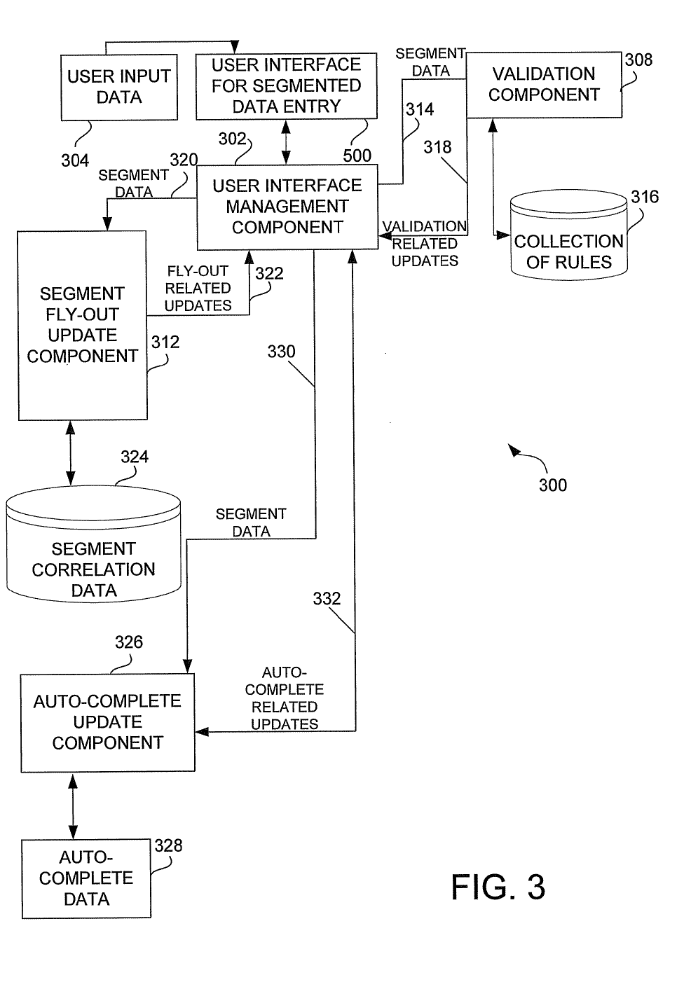

FIG. 3 is a block schematic diagram of a user interface system 300 in accordance with one aspect of the present invention. System 300 schematically demonstrates operation of a series of back-end interface components that support a variety of different functions that become part of a user's experience when interacting with user interfaces that will be described in greater detail elsewhere in the present description.

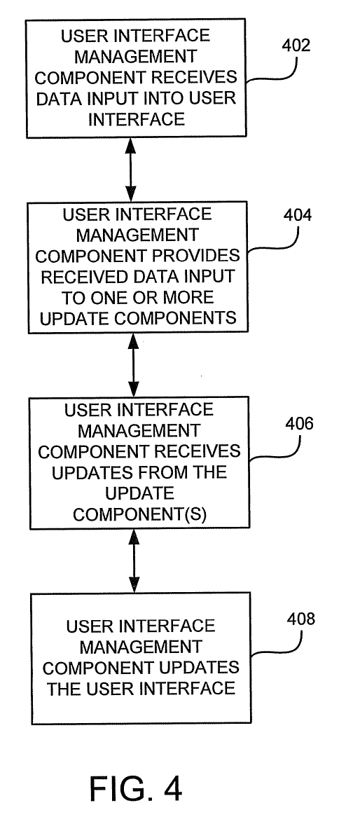

FIG. 4 is a block flow diagram that demonstrates, on a high level, a process scheme applicable to the user interface system 300 of FIG. 3. In accordance with block 402, a user interface management component 302 receives data 304 that was input by a user into a user interface 500. In accordance with block 404, management component 302 provides data 304, or at least a direct or indirect indication thereof, to one or more of update components 308, 312 and 326, various functions of which will be described in greater detail elsewhere in the present description. In accordance with block 406, management component 302 receives update information from the update components to which the user-input data was provided. Finally, in accordance with block 408, management component 302 updates user interface 500 based on the update information received from the update components.

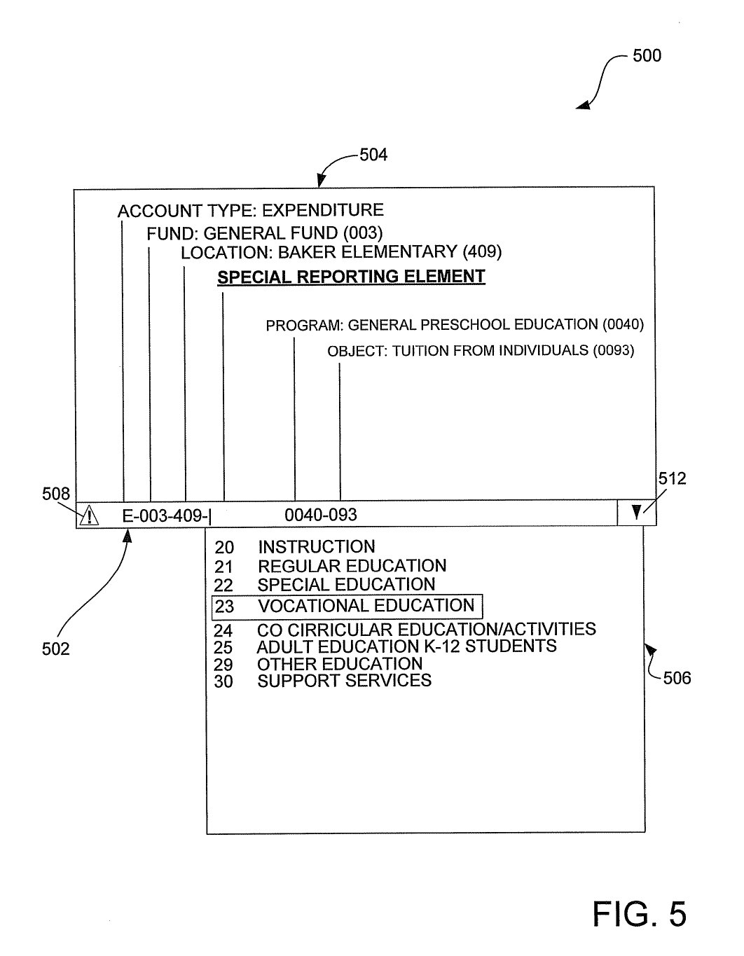

FIG. 5 is a schematic illustration of one embodiment of the user interface 500, which is an interface that supports user entry of segmented account dimension data. Interface 500 includes a data entry component 502, a segment description fly-out component 504, and an auto-complete drop-down component 506. As a whole, interface 500 supports the display and input of data that is segmented in nature, for example a string that includes a plurality of account segments, such as a set of account dimensions. To the extent that the present description refers to an account segment, it is to be understood that an account segment could be any of the sub-components within a segmented indication of an account dimension combination.

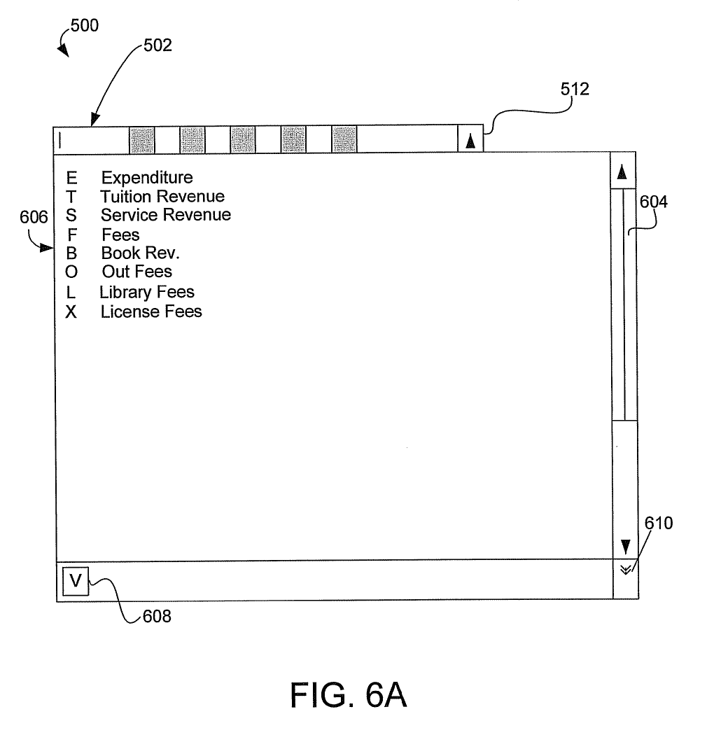

Data entry component 502 includes a selectable control for each of a plurality of account segments, each selectable control being configured to facilitate receipt of user-initiated data input. Component 502 is shown with an illustrative six different selectable account segment controls. A divider separates the individual controls from one another. The scope of the present invention is not limited to any particular type of divider. In FIG. 5, dashes are shown as the dividers. In FIGS. 6A and 6B, the dividers are shaded bars. These options are included in the Figures as examples of the many types of dividers that may be utilized.

The user illustratively selects one of the account segment controls for data entry. In one embodiment, not by limitation, only one of the account segment controls can be selected at a time. In one embodiment, certainly not by limitation, selecting means mouse clicking upon the account segment control. Other selection means (e.g., voice-initiated selection, etc.) are contemplated. Following selection, the user inputs a value into the selected account segment. The present invention is also not limited to any one particular means of data entry. Possibilities include, but are not limited to, typing values in by pressing keys on a keyboard, entering values by way of a voice recognition process, or selecting values from a closed set such as drop menu or an electronically displayed keyboard.

In one embodiment, at some point, such as but not necessarily after each time data is entered into a segment control, a determination is made as to whether the data input by the user into component 502 creates a valid account dimension combination. This validation process is reflected in the schematic system 300 diagram of FIG. 3. Arrow 314 shows delivery of a received segment data (or a direct or indirect indication thereof) to validation component 308. Component 308 performs a validation operation by applying a collection of rules 316 to the segment data. In one embodiment, rules 316 are derived from the relational chart of accounts 102, and/or are or are derived from the account dimension validation rules 110 described in relation to FIG. 1, and/or are manually set as part of administration of the overall system.

The validation may be focused primarily on data entered into a single account segment control. For example, the determination may be focused on whether data input into a currently selected segment control is appropriate (e.g., appropriate format, included in a list of valid possibilities, etc.) for the selected segment control. Also or alternatively, the determination may be scoped for validation of data entered into multiple or all of the account segment controls up to the point of validation. For example, the determination may be whether the overall string including data entered into all of the segment controls is valid. In one embodiment, validation of part or all of the overall combination occurs whenever it is determined to be necessary and/or each time data is entered into any of the account segment controls. It should be noted that the validity determination may be based on whether the dimension set in component 502 is valid (i.e., a valid dimension combination in the applicable context), whether the values entered by the user are valid, or both types of validity determinations may be made as part of the validation process.

Validation update component 308 produces an output representing the outcome of the validation operation. As is demonstrated by arrow 318, the output is provided back to user interface management component 302. Management component 302 then responds as determined to be appropriate in light of the received output. For example, in one embodiment, not by limitation, management component 302 alters or adjusts user interface 500 (FIG. 5). Such alterations/adjustments may include, depending on the circumstances, prohibiting, discouraging or limiting certain or all subsequent input into one or more of the account segment controls. Also or alternatively, component 302 may facilitate the addition or removal of segment controls and/or segment values to or from data entry component 502. Further, user interface 500 includes a validation indicator 508 that is a visual indicator that is adjusted to reflect the validation outcome output received from validation component 308. This gives the user a visual indication of the determined validity or invalidity. This is but one example of a visual indicator that can be utilized to tip off the user that there is an issue that may need to be resolved. Routes to resolution may be independently user-driven, system automated, and/or system guided user-driven.

User interface 500 also includes a fly-out component 504 where account segment descriptions are provided with a visual connection (e.g., a visibly connecting line in FIG. 5) to their associated account segment controls. Further, the segment description fly-out component 504 tracks user focus by visually emphasizing (e.g., by bolding, underlining, unique font, etc.) the segment description that corresponds to the currently selected account segment control. For account segment descriptions in fly-out component 504 for which the corresponding account segment control has already been supplied with a value, that value is illustratively indicated within component 504. For example, entered values are shown within fly-out component 504 in parenthesis next to the applicable segment description.

In many traditional systems, it is required or otherwise necessary to enter dimension values into account segment controls in a certain predetermined order (e.g., entry must be in the consecutive 1-2-3-4-5 order of the segments such that #2 can't be entered until after #1 and so on and so forth). Or, there are at least restrictions that require entry of one segment before entry of another (e.g., hierarchical limitations such that segment #2 cannot be entered unless segment #1 has already been entered, etc.). In accordance with one embodiment, data entry component 502 allows the user to enter account segment values into the account segment controls in any order regardless of being in or out of sequence and, in another embodiment, independent of any hierarchical-based restrictions. Accordingly, rather than being forced to choose account segment values in a sequence order (e.g., entry for segments in the order of “Account-Find-Location-Special Reporting Element-Program-Object”), the smart control of the present invention enables the user to enter account segment values (e.g., account dimension combination values) in any order.

In one embodiment, segment fly-out update component 312 (FIG. 3) dynamically determines valid account segment control combinations based on the currently selected account segment and/or based on one or more currently supplied values (arrow 320 shows segment data provided to component 312). In one embodiment, this means that component 312 itself is the actual source of the processing that applies the validation logic and determines the valid combinations. However, in another embodiment, component 312 instead facilitates acquisition of the valid combination information from a different processing source that applies the validation logic, such as (but not limited to) from validation component 308. User interface management component 302 receives (arrow 322) information related to these determinations. Based on that information, component 302 appropriately updates fly-out component 504 and/or input component 502 so as to provide the user with visible assistance in identifying, in a user-comprehensible way, the number of account segments and the nature of each individual account segment in the likely overall combination. In this manner, update component 312 facilitates, in direct response to user input within component 502, the dynamic updating of how many and which segment controls are included within component 502, and also the dynamic updating of the corresponding segment control descriptors within fly-out component 504.

As is shown in FIG. 3, component 312 analyzes the received segment data in relation to a collection of segment correlation data 324. Again, in another embodiment, component 312 may instead facilitate acquisition of the valid combination information from a different processing source that applies the validation logic, such as (but not limited to) from validation component 308. Regardless of which component actually applies the validation logic, data 324 enables an objective determination as to how many and which account segment controls should be represented within user interface 500, more specifically within data entry component 502 and within fly-out component 504. In one embodiment, the determination is configured to support conformance of component 502 and/or component 504 to a determined likely set of applicable account segment controls. In one embodiment, segment correlation data 324 is derived from the relational chart of accounts 102, is derived from a listing of valid account segment control combinations, is derived from a listing of previously listed account segment control combinations and/or is otherwise manually or automatically set as part of administration of the overall system.

It should be noted that the logic of the determination of how many and which account segments and segment controls should be represented within the interface may be made dependent upon a single account segment or one or more values entered into a single account segment control. Also or alternatively, it can be focused on analysis relative to multiple segments or data entered into multiple or all of the account segment controls up to the point of the determination. In one embodiment, the determination is re-evaluated whenever it is determined to be necessary and/or each time data is entered into any of the account segment controls. Adjustments to component 502 and/or component 504 are made upon each determination.

Accordingly, from a user's perspective, the number and/or combination of account segment controls included within data entry component 502 will sometimes change in direct response to a user-initiated manipulation of the interface such as a particular input into one of the account segment controls. In one embodiment, changes will occur when the particular input is consistent with a new number/combination but is not consistent with the number/combination that existed before the particular input. As the user interacts with the interface (e.g., enters values into the segment controls), user interface components 502 and 504 are automatically updated as necessary to maintain a likely applicable set of account segment controls.

User interface 500 also includes a drop-box component 506 where the user is provided with suggested values for entry into a currently selected account segment control. The list of suggested values within drop-box 506 is a list of values entered during a previous separate entry of account information (e.g., entered historically by the same user when recording a different transaction) into the same account segment control as the currently selected account segment control. In one embodiment, the list of suggested values within drop-box 506 is even further narrowed such that a value is excluded from box 506 if the other values with which it was combined in the historical transaction were different than the other values currently included in data entry component 502. In other words, the values in box 502 are each part of a historically entered combination of account segment values that match the combination of account segment values currently entered into data entry component 502.

With reference to FIG. 3, it is illustratively auto-complete update component 326 that determines which values to include in the suggested values list within box 506. Arrow 330 represents delivery, to auto-complete interface update component 326, of segment data such as data 304 in the form of information indicative of user-initiated selection of an account segment control and/or information indicative of one or more values completely or partially entered by the user into an account segment control. Component 326 processes this received segment data in relation to a collection of auto-complete data 328. In one embodiment, this means comparing the received segment data to a cache of previously entered data so as to identify the candidate values that fit the current context of data already entered within data entry component 502. It should be noted that the logic of the determination as to which historical values to include in the component 506 list may or may not be made dependent upon other current values entered into data entry component 502.

Once the suggested values have been identified, component 326 provides an indication of that information to user interface management component 302. User interface management component 302 then updates the auto-complete drop-down component 506 so as to aid the user's selection of a value for the currently selected account segment control. Those skilled in the art will appreciate that the user is able to scroll down through the suggested values in drop-down interface 506 and select a value for entry into the currently selected account segment control.

In one embodiment, user interface management control 302 is configured to properly align drop-down interface component 506 under data entry component 502. The proper alignment is such that the list of proposed values in interface component 506 is aligned with a point in the selected account component control where a value selected from interface component 506 will be entered. Further, it is noted that, within FIG. 5, interface component 506 includes a small set of eight different suggested account segment values. Those skilled in the art will appreciate that a larger list of suggested could be presented with scroll bar mechanism, a page down mechanism, or some other mechanism for browsing through a more extended set of suggested values.

In one embodiment, drop-down component 506 is configured sort the suggested values in the list so as to provide the user with auto-complete behavior. For example, when the user enters a single character into the selected account segment control, the list is illustratively updated such that values in the list that include that character are illustratively filtered to the top of the list. In one embodiment, entries in the list without the entered character are entirely removed from the list. If the user then enters a second character, the list will be updated again with entries with consecutive instances of the entered first and second characters this time filtering to the top. Again, non-matching entries may be removed. If the user deletes the second character, then the list will revert to the form where ranking preference is given to the first character. Previously removed entries may be added back to the list if they again match the user input. In one embodiment, certainly not by limitation, it is the user interface management component 302 that manages the described auto-complete behavior.

In one embodiment, the auto-complete behavior is not limited to operation relative to a single column or list of data. Within drop-down component 506, two columns of data are shown. Once column illustratively contains a number (i.e., 20, 20, 22 . . . 30) and the other column contains a descriptor for each item in the list (i.e., Instruction, Regular Education . . . Support Services). In one embodiment, the auto-complete filtering of the list based on characters entered within the selected account segment control is applied both to the number column and the descriptor column. For example, if the user enters the “1,” both numbers in the first column and descriptors in the second column that include the number “1” will filter to the top of the auto-complete list (a value without a “1” in any column may be removed from the list). In one embodiment, a system parameter illustratively determines which column is given preference over the other in terms of sorting. If the user then enters a second character to increase the entry to “12,” then the list is resorted with top of the list preference being given to entries, in either column, that include the combination “12.” Again, non-matching entries may be removed. In one embodiment, the auto-complete sorting can be extended not just to two columns of date but more than two columns as well.

With further reference to the user interface 500 of FIG. 5, a button 512 supports transition to a second way for the user to identify desirable account segment values for a currently selected account segment control. Upon selection, button 512 facilitates replacement of (or an otherwise superseding of) drop-down interface 506 with a look-up component 606, which will be described in greater detail below in relation to FIGS. 6A and 6B. User interface management component 302 is illustratively configured to monitor the status of button 512 (or any other similar device within the interface scheme) and facilitate a responsive transition between interface components 506 and 606.

FIG. 6A is another depiction of user interface 500. In this case, no values have yet been entered into any account segment control within data entry interface component 502. However, the first account segment control has been selected so as to activate the control for data entry. In order to simplify the illustration, the fly-out interface component 504 has been removed (illustratively, this removal is a user selectable interface configuration option).

Assumedly, button 512 has been activated so as to instruct/configure management component 302 to provide look-up component 606 as the data entry support mechanism instead of the drop-down component 506 shown in FIG. 5. In other words, based on information communicated by the user via button 512, one of components 506 and 606 will be configured to supercede the other. Notably, look-up component 606, similar to component 506, provides a set of suggested values visually in line with the selected account segment control. Thus, component 606 is aligned in FIG. 6 with the selected first account segment control. Management component 302 illustratively facilitates, automatically, this alignment to the selected control.

A significant difference between drop-down component 506 and look-up component 606 is the nature of the suggested values included in the respective lists. As has been described, the suggested values list within component 506 is derived from a cache of previously selected values. In contrast, the suggested values list within component 606 is illustratively a list of values determined to be valid entries for the currently selected account segment control. In one embodiment, the validity determination in this context is extended to factor in relativity to other values that have been, at the time of determination, already set within other segment controls within data entry component 502. In other words, choosing a value from the list within look-up component 606 will create a valid combination of values defined in conjunction with other values already entered into component 502. A range of different types of validity determinations was described above in relation to validation component 308. Any of those or any other basis for validity can, without departing from the scope of the present invention, be adopted as the basis for filtering the list in component 606. Regardless of the validity basis, drop down interface 606 provides the user with an option of seeing all valid values for the currently selected account segment control, rather than only values that have been already historically selected.

Those skilled in the art will appreciate that scroll mechanism 604 enables the user to move through a list that exceeds the dimensions of the allocated display area within interface component 606. The present invention is not limited to a scroll bar. In one embodiment, a “page down” mechanism or some other similar device is substituted for the scroll bar. A page down mechanism illustratively enables the user to page through, one page at a time, small sub-lists of values that fit within the display area.

In one embodiment, when look-up component 606 is displayed, button 512 provides a means for transitioning back to interface component 506. Again, user interface management component 302 is illustratively configured to monitor the status of button 512 (or any other similar device within the interface scheme) and facilitate the responsive transition between interface components 506 and 606.

As is shown in FIG. 6A, look-up component 606 is displayed in conjunction with a toggle button 608, which is also illustratively monitored and managed by user interface management component 302. In one embodiment, pressing button 608 will adjust the list of candidate values within drop-down component 606 to include ALL values relevant to the currently selected segment control, not just valid values. There are many reasons why a user might want to do this. For example, a user might want to select and enter an invalid account number without interrupting their current work with the thought that they will return later to account set up functionality (e.g., a tool that enables adjustments to data 328, 316, the table of accounts 102, validation rules 110, etc.) and make the account number a valid one. This is but one example of a circumstance in which a user might desire access to invalid values. Those skilled in the art will appreciate that again pressing toggle button 608 illustratively transitions the list in look-up component 606 back to the set of valid values only.

The functionality of look-up component 606 is illustratively facilitated by auto-complete update component 326 shown in FIG. 3. Similar to when supporting drop-down component 506, component 326 again receives, in accordance with arrow 330, segment data. The segment data is illustratively in the form of information indicative of user-initiated selection of an account segment control and/or information indicative of one or more values entered by the user into an account segment control. Component 326 again analyzes this received segment data in relation to a collection of auto-complete data 328 but illustratively factors in validity restrictions reflected in the collection of rules 316, the relational chart of accounts 102, account validation rules 110, etc. depending on the adopted basis for validity. Component 326 determines valid values or all possible values for the selected account segment control, depending upon a received request from management component 302, the request reflecting the status of toggle button 608.

Auto-complete interface update component 326 produces an output representing the outcome of the determination. As is demonstrated by arrow 332, the output is provided back to user interface management component 302. Management component 302 then responds as determined to be appropriate in light of the received output. For example, in one embodiment, management component 302 populates look-up component 606 with the appropriate data.

A control options button 610 is also shown in FIG. 6A. User interface management component 302 is illustratively configured to monitor button 610 for actuation and facilitate a responsive transition between interface components. In particular, pressing button 610 on and off illustratively causes a toggling between on and off display of one or more controls for selecting preferred display behavior options.

In one embodiment, toggle button 610 enables access to behavior options buttons 612 and 614 shown in FIG. 6B. User interface management component 302 is illustratively configured to monitor the selection status buttons 612 and 614. If button 612 is not selected (e.g., is not “checked”), the user presented with data entry component 502 will not be presented with auto-complete fly-out boxes such as boxes 506 and 606 shown and described in relation to FIGS. 5, 6A and 6B. Similarly, if button 614 is not selected (e.g., is not “checked”), the user presented with data entry component 502 will not be presented with segment description fly-out component 504 described in relation to FIG. 5. In other words, button 610 provides access to mechanisms for controlling the behavior of interface 500 through selection of controls for enabling or disabling the related components. Those skilled in the art that these types of mechanisms for adjusting interface characteristics can be positioned anywhere within or outside of interface 500. It is also to be understood that the present invention is not limited to any particular type of user interface control for making such adjustments. Numerous mechanisms for configuring behavior options are well known in the art and are all within the scope of the present invention.

Within FIGS. 5, 6A, and 6B, data entry component 502 is shown as including one account segment control that is allocated more space horizontally (i.e., width from left to right) than the other account segment controls. In one embodiment, user interface management component 302 is configured to widen the appearance of the currently selected account segment control as a mechanism for visibly emphasizing the selected control so as to make it stand out from the non-selected controls. In one embodiment, user interface management component 302 is configured to otherwise visually emphasize the selected control such as, but not limited to, placing a blinking cursor within the selected control.

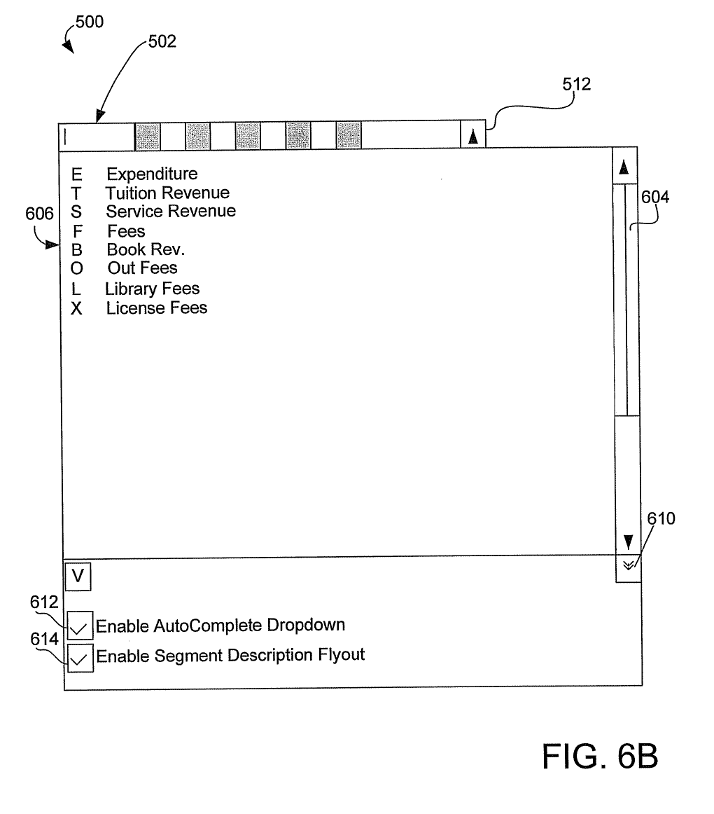

FIG. 7A is a schematic illustration of an embodiment of a portion of user interface 500, more particularly a portion of data entry component 502. This Figure is intended to demonstrate that, in one embodiment, text entered into a selected account segment control within data entry component 502 is allowed to exceed the amount of horizontal space allocated to the control box portion of the interface. In one embodiment, in such circumstances, new characters continue to be accepted on the right-hand side of the control box while, correspondingly, characters are removed from the left-hand side.

Thus, the text that does not fit within the control box appears to scroll out of the left-hand side of the box. Those skilled in the art will appreciate that the user can move the cursor in either direction in order to scroll the text box across the total entry of text. In other words, the user can move the cursor toward the left-hand side of the box in order to re-display text that has appeared to have dropped out of the display box. In this case, text on the right-hand side will appear to drop out of the display. Then, the user can move the cursor toward the right-hand side of the box in order to re-display text that has appeared to have dropped out of the display box. In one embodiment, when data entry into the control box is determined to be complete (e.g., when the user selects a different account segment), the control shows as much of the completed information as is possible in the visible display area. For example, as much text as possible is shown beginning from the left-hand side of the strong of text.

In one embodiment, as demonstrated in FIG. 7B, an ellipsis 702 is provided as an indicator that additional information exists. Those skilled in the art will appreciate that the control can be, at any time, re-selected and the cursor utilized to move back and forth so as to scroll the visible window across all of the entered text. In one embodiment, of course, the value can also be edited again when the control is re-selected. The user interface management component 302 is illustratively configured to facilitate the text entry functionality and behavior described in relation to FIGS. 7A and 7B.

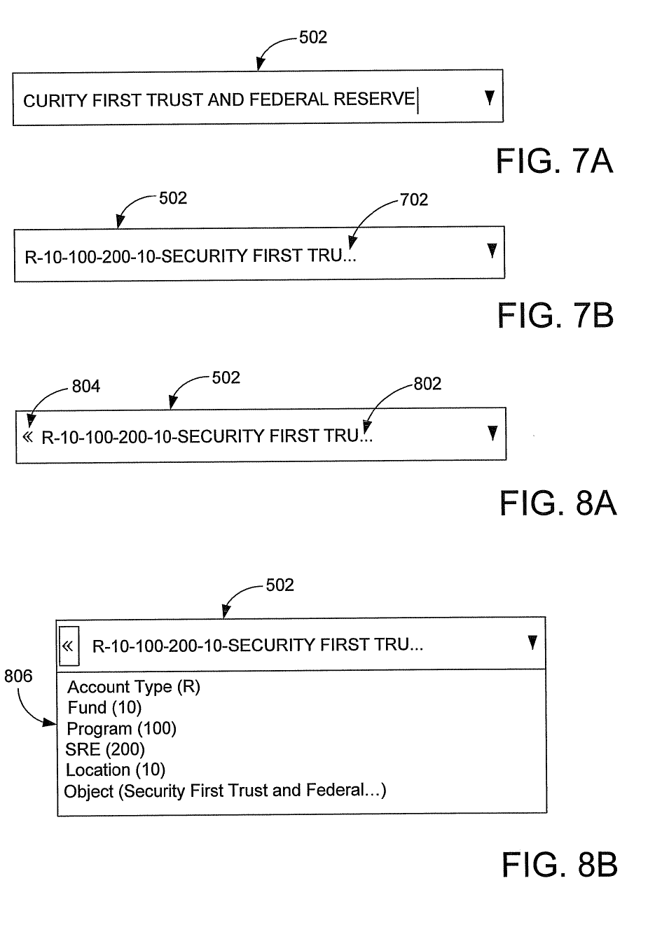

FIG. 8A is a schematic illustration of an embodiment of data entry component 502. This Figure is intended to demonstrate that, in one embodiment, when the number of account segment controls exceeds the visible space allocated to component 502, the control will display as much of the completed account data as possible in the visible display area. An ellipsis 802 is illustratively utilized to indicate that more information exists in the right-hand direction. A chevron 804 illustratively appears just before the first account segment control. The chevron 804 is illustratively configured to enable the user to toggle on and off a drop-down box 806 (FIG. 8B) that shows the segment name and current values for all of the segments. Of course, those skilled in the art will appreciate that the scope of the present invention certainly is not limited to a chevron in particular. Any other similar indicator and/or functionality should also be considered within the scope of the present invention.

In one embodiment, selecting (e.g., mouse clicking upon) one of the account segment controls within data entry component 502 will cause the corresponding listing within drop-down box 806 to become visually highlighted. This is shown demonstrated in FIG. 8C where the user has illustratively selected (e.g., mouse clicked upon) the “200” value entered into one of the account segment controls. Notably, this selection is indicated by the cursor within the control box and the increase in horizontal space relative to the other control boxes. Illustratively, when this selection occurred, the corresponding entry within drop-down box 806 automatically became highlighted (e.g., a visually emphasizing box was automatically place around the corresponding entry).

In one embodiment, the user is able to move (e.g., by inputting an up-arrow or down arrow command into the keyboard) the highlight within box 806 so as to move the emphasis up or down from one listed value to another. In one embodiment, this causes the selected control status within data entry component 502 to automatically change in relation. In FIG. 8D, the user has illustratively entered a “down” command and thereby caused the visual emphasis in box 806 to transfer from the SRE (200) value to the Location (10) value. This illustratively caused, automatically, the account segment control containing the 200 value to become unselected and the account segment control 10 to become selected (note in FIG. 8D the cursor placement within component 502 and the expanded horizontal space allocation indicating selection of the control). Thus, the user is able to navigate through one of components 502 and 806 by making selection inputs in the other. Those skilled in the art will appreciate that box 806 may have a scroll, page down, or some other mechanism to enable the user to move through a list that exceeds the vertical dimensions of the allocated display area.

In one embodiment, the user is able to enter text into a selected account segment control by entering text into the visually highlighted area within box 806. In other words, with reference to FIG. 8D, changing “Location (10)” within box 806 to “Location (20)” will illustratively effectuate the same change in the corresponding account segment control within component 502. Of course the changes can go the other way as well (i.e., changes in box 502 effectuate corresponding changes in box 806). Text entries within a selected line within box 806 are illustratively configured to behave in a manner similar to that described in relation to FIGS. 7A and 7B. In other words, the line within box 806 behaves like an account segment control when the string of text exceeds the available horizontal space. The user interface management component 302 is illustratively configured to facilitate the functionality and behavior described in relation to FIGS. 8A-8D.

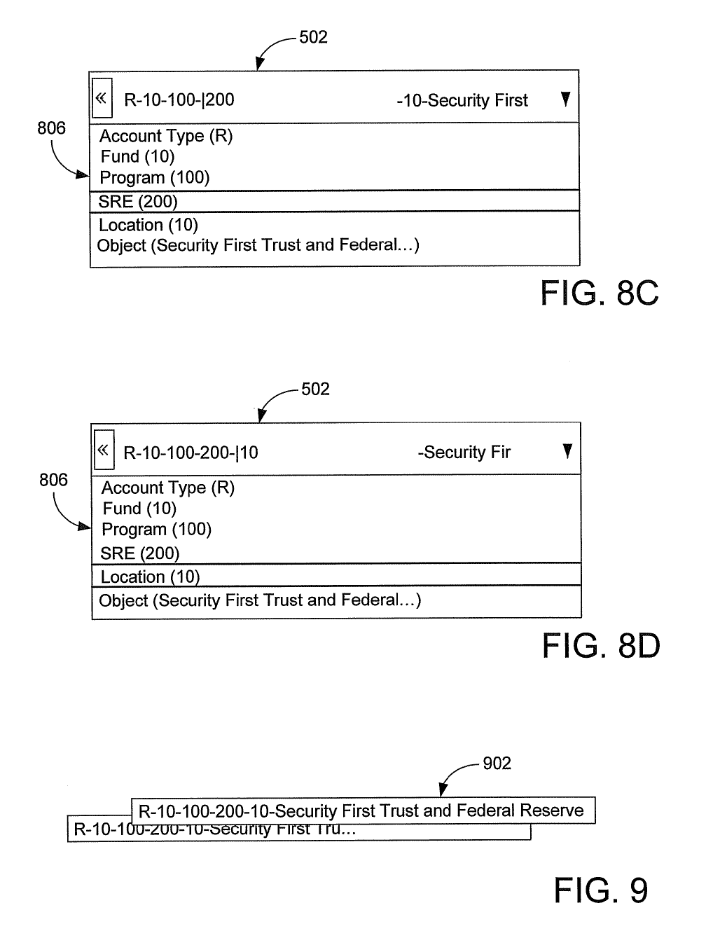

FIG. 9 demonstrates one more function/behavior illustratively facilitated by interface management component 302. As has been described, it will sometimes happen that not all account information will fit within data entry component 502 (such as when the described ellipsis or chevron is inserted to show other information is available). In this case, when the user maintains a selection input (e.g., hovers a mouse pointer) over data entry component 502 for a predetermined amount of time (e.g., based on a system parameter), a pop up box 902 will appear with the entire account segment combination shown within.

Accordingly, embodiments described herein pertain to a control that allows the user to conveniently and efficiently input an account and dimension combination. The control will illustratively validate the account and dimension combination as it is entered, for example, as it is entered upon the General Ledger distribution line for any transaction. Information from the transaction is, in one embodiment, utilized to determine which rule(s) to validate against. The control also illustratively provides valid lists of dimensions determined to be consistent with the currently provided or selected dimensions. These are just some of many benefits of the described embodiments of the present invention.

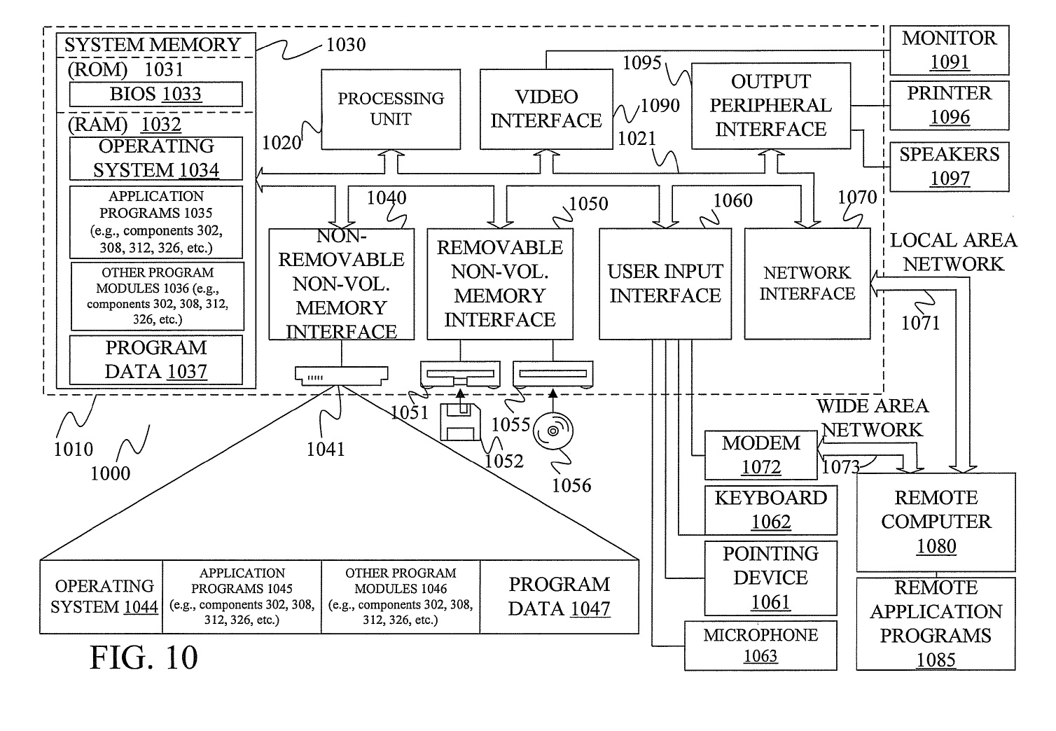

FIG. 10 illustrates an example of a suitable computing system environment 1000 on which embodiments described herein may be implemented. The computing system environment 1000 is only one example of a suitable computing environment and is not intended to suggest any limitation as to the scope of use or functionality of various embodiments. Neither should the computing environment 1000 be interpreted as having any dependency or requirement relating to any one or combination of components illustrated in the exemplary operating environment 1000.

Embodiments are operational with numerous other general purpose or special purpose computing system environments or configurations. Examples of well-known computing systems, environments, and/or configurations that may be suitable for use with various embodiments include, but are not limited to, personal computers, server computers, hand-held or laptop devices, multiprocessor systems, microprocessor-based systems, set top boxes, programmable consumer electronics, network PCs, minicomputers, mainframe computers, telephony systems, distributed computing environments that include any of the above systems or devices, and the like.

Embodiments may be described in the general context of computer-executable instructions, such as program modules, being executed by one or more computers. Generally, program modules include routines, programs, objects, components, data structures, etc. that perform particular tasks or implement particular abstract data types. Some embodiments are designed to be practiced in distributed computing environments where tasks are performed by remote processing devices that are linked through a communications network. In a distributed computing environment, program modules are located in both local and remote computer storage media including memory storage devices.

With reference to FIG. 10, an exemplary system for implementing some embodiments includes a general-purpose computing device in the form of a computer 1010. Components of computer 1010 may include, but are not limited to, a processing unit 1020, a system memory 1030, and a system bus 1021 that couples various system components including the system memory to the processing unit 1020. The system bus 1021 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

Computer 1010 typically includes a variety of computer readable media. Computer readable media can be any available media that can be accessed by computer 1010 and includes both volatile and nonvolatile media, removable and non-removable media. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computer 1010. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer readable media.

The system memory 1030 includes computer storage media in the form of volatile and/or nonvolatile memory such as read only memory (ROM) 1031 and random access memory (RAM) 1032. A basic input/output system 1033 (BIOS), containing the basic routines that help to transfer information between elements within computer 1010, such as during start-up, is typically stored in ROM 1031. RAM 1032 typically contains data and/or program modules that are immediately accessible to and/or presently being operated on by processing unit 1020. By way of example, and not limitation, FIG. 10 illustrates operating system 1034, application programs 1035, other program modules 1036, and program data 1037.

The computer 1010 may also include other removable/non-removable volatile/nonvolatile computer storage media. By way of example only, FIG. 10 illustrates a hard disk drive 1041 that reads from or writes to non-removable, nonvolatile magnetic media, a magnetic disk drive 1051 that reads from or writes to a removable, nonvolatile magnetic disk 1052, and an optical disk drive 1055 that reads from or writes to a removable, nonvolatile optical disk 1056 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 1041 is typically connected to the system bus 1021 through a non-removable memory interface such as interface 1040, and magnetic disk drive 1051 and optical disk drive 1055 are typically connected to the system bus 1021 by a removable memory interface, such as interface 1050.

The drives and their associated computer storage media discussed above and illustrated in FIG. 10, provide storage of computer readable instructions, data structures, program modules and other data for the computer 1010. In FIG. 10, for example, hard disk drive 1041 is illustrated as storing operating system 1044, application programs 1045, other program modules 1046, and program data 1047. Application programs 1045 can include automated accounting software and/or an entire enterprise resource planning (ERP) system. Note that these components can either be the same as or different from operating system 1034, application programs 1035, other program modules 1036, and program data 1037. Operating system 1044, application programs 1045, other program modules 1046, and program data 1047 are given different numbers here to illustrate that, at a minimum, they are different copies.

A user may enter commands and information into the computer 1010 through input devices such as a keyboard 1062, a microphone 1063, and a pointing device 1061, such as a mouse, trackball or touch pad. Other input devices (not shown) may include a joystick, game pad, satellite dish, scanner, or the like. These and other input devices are often connected to the processing unit 1020 through a user input interface 1060 that is coupled to the system bus, but may be connected by other interface and bus structures, such as a parallel port, game port or a universal serial bus (USB). A monitor 1091 or other type of display device is also connected to the system bus 1021 via an interface, such as a video interface 1090. In addition to the monitor, computers may also include other peripheral output devices such as speakers 1097 and printer 1096, which may be connected through an output peripheral interface 1095.

The computer 1010 is operated in a networked environment using logical connections to one or more remote computers, such as a remote computer 1080. The remote computer 1080 may be a personal computer, a hand-held device, a server, a router, a network PC, a peer device or other common network node, and typically includes many or all of the elements described above relative to the computer 1010. The logical connections depicted in FIG. 10 include a local area network (LAN) 1071 and a wide area network (WAN) 1073, but may also include other networks. Such networking environments are commonplace in offices, enterprise-wide computer networks, intranets and the Internet.

When used in a LAN networking environment, the computer 1010 is connected to the LAN 1071 through a network interface or adapter 1070. When used in a WAN networking environment, the computer 1010 typically includes a modem 1072 or other means for establishing communications over the WAN 1073, such as the Internet. The modem 1072, which may be internal or external, may be connected to the system bus 1021 via the user input interface 1060, or other appropriate mechanism. In a networked environment, program modules depicted relative to the computer 1010, or portions thereof, may be stored in the remote memory storage device. By way of example, and not limitation, FIG. 10 illustrates remote application programs 1085 as residing on remote computer 1080. It will be appreciated that the network connections shown are exemplary and other means of establishing a communications link between the computers may be used.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A computer-implemented user interface system for facilitating entry of segmented account dimension data, the system comprising:
a data entry user interface component that includes a selectable account segment control that receives a user-initiated input of an account dimension value, said receipt causing the account dimension value to become a set value for a particular account dimension for which the selectable account segment control was pre-designated prior to the receipt of the user-initiated input;
an interface update component that utilizes a computer processor that is a functional component of the computer to compare the user-initiated input of the account dimension value to a record of account dimensions that are identified as being relevant to the account dimension value included in the user-initiated input, wherein the interface update component also provides an output indicative of the comparison; and
a user interface management component that receives the output from the interface update component and, based on the output from the interface update component, changes a total number of selectable account segment controls included in the data entry user interface component.

2. The system of claim 1, wherein the selectable account segment control is visually presented, on a display that is a functional component of the computer, as part of a set of multiple visually presented individually selectable account segment controls, wherein a different account dimension is pre-designated to each individually selectable account segment control in the set, and wherein selection of one of the individually selectable account segment controls in the set causes the visual appearance of the selected individually selectable account segment control to change in shape so as to distinguish from the non-selected individually selectable account segment control.

3. The system of claim 1, wherein the selectable account segment control receives the user-initiated input of the account dimension value by way of a selection of the account dimension value from an auto-complete interface component that includes a list of suggested dimension values for the selectable account segment control, wherein the auto-complete interface component and the data entry user interface component are simultaneously presented within a user interface in close proximity to one another.

4. The system of claim 3, wherein the list of suggested dimension values in the auto-complete interface component includes values identified by an auto-complete update component as being values that would contribute to an overall valid combination of values when combined with at least one other value already entered into another selectable account segment control included within the data entry user interface component.

5. The system of claim 3, wherein the list of suggested dimension values in the auto-complete interface component includes values selected by an auto-complete update component from a cache of previously entered values for the selectable account segment component.

6. The system of claim 1, further comprising an auto-complete interface component that includes a list of suggested dimension values for the selectable account segment control, and wherein the composition of the list of suggested values automatically changes based on a result of a comparison of text characters entered into the selectable account segment control with text included in suggested values in the list.

7. The system of claim 6, wherein the list of suggested dimension values in the auto-complete interface component is edited to exclude values identified by an auto-complete update component as being values that would not contribute to an overall valid combination of values when combined with at least one other value already entered into another selectable account segment control included within the data entry user interface component.

8. The system of claim 1, further comprising an auto-complete interface component that includes a list of suggested dimension values for the selectable account segment control, wherein the composition of the list of suggested values automatically changes based on a result of a comparison of text characters entered into the selectable account segment control with text included in multiple columns of data for each suggested values in the list.

9. The system of claim 1, further comprising a fly-out user interface component that provides a description of the particular account dimension, wherein the fly-out user interface component and the data entry user interface component are simultaneously presented within a user interface in close proximity to one another.

10. The system of claim 1, wherein the user interface management component, based on the output from the interface update component, changes the total number of selectable account segment controls included in the data entry user interface component by adding a new selectable account segment control to the data entry user interface component.

11. The system of claim 10, wherein the user interface management component, based on the output from the interface update component, updates a fly-out user interface component to include a description of an account dimension for which the new account segment control is designated, and wherein the fly-out user interface component and the data entry user interface component are simultaneously presented within a user interface in close proximity to one another.

12. The system of claim 1, wherein the fly-out user interface component and the data entry user interface component are simultaneously presented within a user interface in close proximity to an auto-complete interface component that includes a list of suggested dimension values for the selectable account segment control.

13. A computer-implemented method for facilitating a user-initiated entry of a segmented account dimension combination on a general ledger distribution line for a record of a transaction within an accounting application, the method comprising utilizing a computer processor that is a functional component of the computer to provide, on a display that is also a functional component of the computer, a data entry user interface component that includes a series of individually selectable segmented controls that enable the user to select the account dimension combination without any restriction on the order in which the segmented controls are supplied with values.

14. The method of claim 13, further comprising utilizing the computer processor to dynamically modify the series of segmented controls in response to a data input by the user into one of the series of segmented controls.

15. The method of claim 14, wherein dynamically modifying comprises changing the number of segmented controls in the series of segmented controls.

16. The method of claim 14, further comprising:
providing, simultaneously on the display with the data entry user interface component, a fly-out interface component that includes a description of a presumed nature of content of each control in the series of segmented controls.

17. The method of claim 16, wherein the method further comprises automatically updating the fly-out component so as to revise the description to reflect an automatically effectuated change in the number of segment control in the series of segmented controls.

18. A computer-implemented method for facilitating a user-initiated entry of a segmented account dimension combination on a general ledger distribution line for a record of a transaction within an accounting application, the method comprising:
utilizing a computer processor that is a functional component of the computer to provide, on a display that is also a functional component of the computer, a data entry user interface component that includes a series of individually selectable segmented controls;
utilizing the processor to provide, simultaneously on the display with the data entry user interface component, a drop-box interface component provides a list of suggested values for a selected one of the series of segmented controls; and
wherein the computer processor automatically modifies the list of suggested values so as to give a top list preference to suggested values that contain a string of text characters, in either of at least two different columns of data included in the suggested value, that matches a string of text characters that has been entered by the user into the selected one of the series of segmented controls as part of a partial entry of a dimension value.

19. The method of claim 18, wherein the list of suggested values are limited to values derived from a cache of values previously entered into the selected one of the series of segment controls during a separate, historic creation of a record of a different transaction.

20. The method of claim 18, wherein the list of suggested values are limited to values determined to be valid entries for the selected one of the series of segment controls.
